(19) United States
(12) Patent Application Publication
(10) Pub. No.: US 2017/0251084 A1
(43) Pub. Date: Aug. 31, 2017

(54) APPARATUS AND METHOD FOR NETWORK ASSISTED DOMAIN SELECTION

(71) Applicant: Intel IP Corporation, Santa Clara, CA (US)

(72) Inventors: Jerome Parron, Fuerth (DE); Vivek G. Gupta, San Jose, CA (US); Robert Zaus, Munchen (DE); Frank Kowalewski, Goettingen (DE)

(21) Appl. No.: 15/519,639

(22) PCT Filed: Oct. 14, 2015
(86) PCT No.: PCT/US2015/055436

§ 371 Date: Apr. 17, 2017

Related U.S. Application Data
(60) Provisional application No. 62/080,869, filed on Nov. 17, 2014.

(51) Int. Cl. H04L 29/14; H04L 29/06; H04W 64/00; H04L 29/08; H04W 48/18

(52) U.S. Cl. CPC H04L 69/40; H04L 67/148; H04L 67/18; H04W 48/18; H04W 64/006; H04L 69/28; H04W 84/045

(57) ABSTRACT

Embodiments of a User Equipment (UE) for initiating a service in a cellular network are disclosed herein. The UE can include processing circuitry to initiate the service for a service type using a current domain. Additionally, the UE can detect a service initiation failure for the service. Moreover, the UE can generate domain selection assistance information (DSAI) based on the detected service initiation failure. The DSAI can include the service type and the current domain. Furthermore, the UE can include transceiver circuitry to send the DSAI to a network entity. The network entity can be a diagnostic and assistance server. The sending of the DSAI can be configured to assist the network entity in selecting a preferred domain for the service type for the case when the UE initiates a new service.

### PRIORITY CLAIM

This application claims the benefit of priority to U.S. Provisional Patent Application Ser. No. 62/080,869, filed Nov. 17, 2014, which is incorporated herein by reference in its entirety.

### TECHNICAL FIELD

Embodiments pertain to wireless communications. Some embodiments relate to cellular communication networks, including networks configured to operate in accordance with the third-generation partnership project (3GPP) long term evolution (LTE) and LTE-advanced (LTE-A) standards. Some embodiments relate to enhancing the initiation of a service by dynamically selecting a domain.

### BACKGROUND

With the introduction of Internet Protocol (IP) Multimedia Subsystem (IMS), services such as voice, video call, Short Message Service (SMS), or supplementary services may be performed either on the IMS or on a Circuit Switched (CS) domain.

In current implementations, a User Equipment (UE) can initiate a service using a domain (e.g., IMS or CS) using a static order of preference for the different domains.

However, when a service initiation failure occurs on the initial domain, the UE fails to execute the service. In a subsequent initiation of a new service, the UE will start the initiation process using the initial domain again, which will likely fail again. As a result, retrying to initiate a service using current implementations can lead to additional delay.

### BRIEF DESCRIPTION OF THE DRAWINGS

FIG. 1 is a functional diagram of a 3GPP network, in accordance with some embodiments;

FIG. 2 is a functional diagram of a UE, in accordance with some embodiments;

FIG. 3 is a functional diagram of a diagnostic and assistance server, in accordance with some embodiments;

FIG. 4 illustrates a flow diagram of components of a UE, in accordance with some embodiments;

FIG. 5 illustrates an example of a scenario of a diagnostic and assistance server in a 3GPP network, in accordance with some embodiments;

FIG. 6 illustrates an example of a communication between the UE and the diagnostic and assistance server during a service setup failure notification, in accordance with some embodiments;

FIG. 7 illustrates an example of a communication between the UE and the diagnostic and assistance server during an assistance request, in accordance with some embodiments;

FIG. 8 illustrates an example of a communication between the UE and the diagnostic and assistance server during an assistance notification, in accordance with some embodiments;

FIG. 9 illustrates a scenario of an emergency call setup failure on an IMS domain followed by a retry on a CS domain, in accordance with some embodiments;

FIG. 10 illustrates some of the parameters of an Open Mobile Alliance (OMA) management object (MO) for an access network discovery and selection function (ANDSF), in accordance with some embodiments;

FIG. 11 illustrates the operation of a method for a UE to initiate a service in a mobile communication network and providing domain selection assistance information (DSAI), in accordance with some embodiments; and

FIG. 12 illustrates the operation of a method for a diagnostic and assistance server assisting a UE with domain selection assistance data (DSAD) for initiation of a new service in a mobile communication network, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

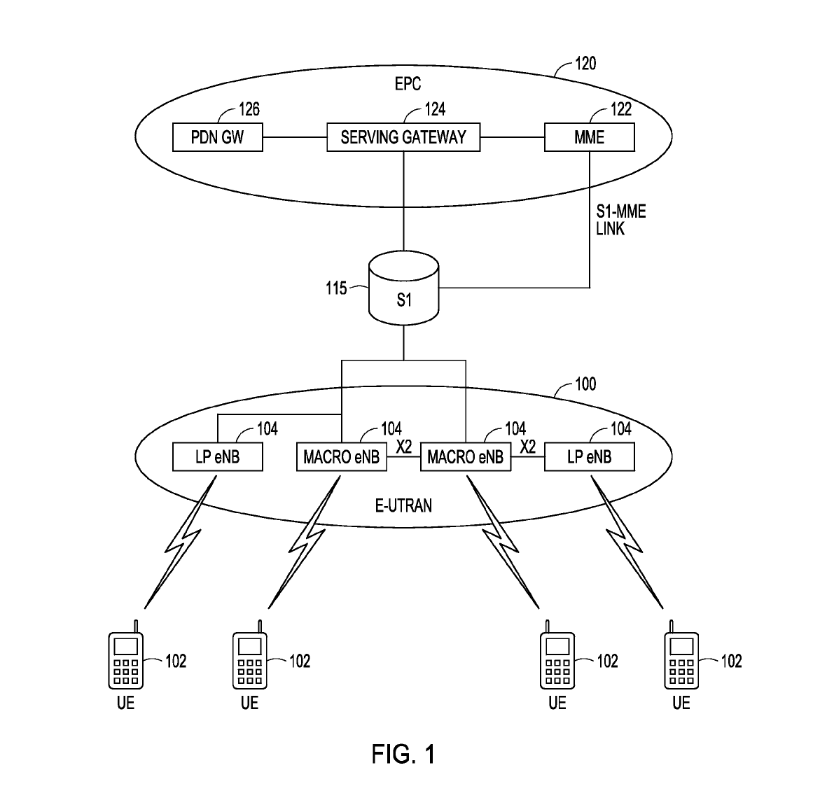

As an overview, FIGS. 1-3 illustrate functional diagrams of an exemplary 3GPP network, a UE, and an eNB, respectively.

FIG. 1 is a functional diagram of a 3GPP network, in accordance with some embodiments. The network comprises a radio access network (RAN) (e.g., as depicted, the E-UTRAN or evolved universal terrestrial radio access network) 100 and a core network 120 (e.g., shown as an EPC) coupled together through an S1 interface 115. For the sake of convenience and brevity, only a portion of the core network 120, as well as the RAN 100, is shown.

The core network 120 includes a mobility management entity (MME) 122, serving gateway (serving GW) 124, and a packet data network gateway (PDN GW) 126. The RAN 100 includes eNBs 104 (which may operate as base stations) for communicating with UEs 102. The eNBs 104 may include macro eNBs and low power (LP) eNBs, such as micro eNBs.

The MME 122 is similar in function to the control plane of legacy Serving GPRS Support Nodes (SGSN). The MME 122 manages mobility aspects in access such as GW selection and tracking area list management. The serving GW 124 terminates the interface toward the RAN 100, and routes data packets between the RAN 100 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates a SGi interface toward the PDN. The PDN GW 126 routes data packets between the core network 120 and the external PDN, and may be a key node for policy enforcement and charging data collection. It may also provide an anchor point for mobility with non-LTE accesses. The external PDN can be any kind of IP network, as well as an IMS domain. The PDN GW 126 and the serving GW 124 may be implemented in one physical node or separate physical nodes.

The eNBs 104 terminate the air interface protocol and may be the first point of contact for a UE 102. In some embodiments, an eNB 104 may fulfill various logical functions for the RAN 100 including but not limited to RNC (radio network controller functions) such as radio bearer management, uplink and downlink dynamic radio resource management and data packet scheduling, and mobility management. In accordance with embodiments, UEs 102 may be configured to communicate orthogonal frequency-division multiplexing (OFDM) communication signals with an eNB 104 over a multicarrier communication channel in accordance with an orthogonal frequency-division multiple access (OFDMA) communication technique. The OFDM signals may comprise a plurality of orthogonal subcarriers.

The S1 interface 115 is the interface that separates the RAN 100 and the core network 120. It is split into two parts: the S1-U, which carries data traffic between the eNBs 104 and the serving GW 124, and the S1-MME, which is a signaling interface between the eNBs 104 and the MME 122. The X2 interface is the interface between eNBs 104. The X2 interface comprises two parts, the X2-C and X2-U. The X2-C is the control plane interface between the eNBs 104, while the X2-U is the user plane interface between the eNBs 104.

In cellular networks, low power (LP) cells are typically used to extend coverage to indoor areas where outdoor signals do not reach well, or to add network capacity in areas with dense phone usage, such as train stations. As used herein, the term “LP eNB” refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. In some instances, a home eNB gateway may be inserted between a home eNB (e.g., femtocell eNB) and the MME 122 and serving gateway 124. The home eNB gateway can control several Home eNBs and concentrates the user data and signaling traffic from the home eNBs towards the MME 122 and serving gateway 124. Similarly, a picocell is a wireless communication system typically covering a small area, such as in-building (offices, shopping malls, train stations, etc.), or, more recently, in-aircraft. A picocell eNB can generally connect through the X2 link to another eNB such as a macro eNB through its base station controller (BSC) functionality. Additionally, the picocell eNB is connected via an S1 interface to an MME 122 or service gateway 124. Thus, an LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell.

In some embodiments, a downlink resource grid may be used for downlink transmissions from an eNB 104 to a UE 102, while uplink transmissions from the UE 102 to the eNB 104 may utilize similar techniques. The grid may be a time-frequency grid, called a resource grid or time-frequency resource grid, which is the physical resource in the downlink in each slot. Such a time-frequency plane representation is common for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. There are several different physical downlink channels that are conveyed using such resource blocks. With particular relevance to this disclosure, two of these physical downlink channels are the physical downlink shared channel (PDSCH) and the physical downlink control channel (PDCCH).

The PDSCH carries user data and higher-layer signaling to a UE 102. The PDCCH carries information about the transport format and resource allocations related to the PDSCH channel, among other things. It also informs the UE 102 about the transport format, resource allocation, and hybrid automatic repeat request (HARQ) information related to the uplink shared channel. Typically, downlink scheduling (assigning control and shared channel resource blocks to UEs 102 within a cell) is performed at the eNB 104 based on channel quality information fed back from the UEs 102 to the eNB 104, and then the downlink resource assignment information is sent to a UE 102 on the PDCCH used for (assigned to) the UE 102.

The PDCCH uses control channel elements (CCEs) to convey the control information. Before being mapped to resource elements, the PDCCH complex-valued symbols are first organized into quadruplets, which are then permuted using a sub-block inter-leaver for rate matching. Each PDCCH is transmitted using one or more of these CCEs, where each CCE corresponds to nine sets of four physical resource elements known as resource element groups (REGs). Four quadrature phase-shift keying (QPSK) symbols are mapped to each REG. The PDCCH can be transmitted using one or more CCEs, depending on the size of DCI and the channel condition. There may be four or more different PDCCH formats defined in LTE with different numbers of CCEs (e.g., aggregation level L=1, 2, 4, or 8).

As previously mentioned, services such as voice, video call, SMS, or supplementary services can be performed either on a packet switched (PS) domain (e.g., IMS), or on a CS domain. Additionally, the IMS service may be performed on different access technologies (e.g., LTE, High Speed Packet Access (HSPA), and Wireless Local Area Network (WLAN)). Additionally, service initiation failure can lead to additional delay and may influence other services. For instance, a move from LTE to Global System for Mobile Communications (GSM) due to a service initiation failure which occurred in LTE can impact the service capability offered to the user.

Current 3GPP standards may only define some criteria to determine the order of preference regarding on which domain to first initiate a service. However, the standards do not provide any method on how to change the priority order if a service fails on the preferred domain.

According to various embodiments, the UE 102 can determine the domain and access technology to use to initiate a service based on some preferences and capabilities. Techniques are described herein for changing the priority order for selecting a domain based on a service initiation failure.

For example, the criteria to select the preferred domain can be based on a registration status, a network capability indicator, or preference configuration parameter. The registration status can be for a PS and CS domain, such as the CS attach, General Packet Radio Service (GPRS), or Evolved Packet System (EPS) attach. Additionally, the registration status can be the IMS registration status for the various multimedia services, such as the Multimedia Telephony Service (MMTel). The network capability indicator can include an indicator for support of emergency bearer services in a GPRS network, an indicator for support of emergency bearer services in an EPS network, an indicator for support of IMS voice in a GPRS network, and an indicator for support of IMS voice in an EPS network. The preference configuration can be a preference parameter for voice or SMS services, such as a voice domain preference parameter.

Additionally, the normal priority order can also be affected if certain mobility management procedures (e.g., routing, or tracking area update) are failing, but in these cases the UE 102 can determine that a certain domain is not available for any service.

However, in case of temporary or permanent failure (e.g., due to network issues or network overload), the device (e.g., UE 102) may not be informed in advance about which network (e.g., RAN 100) to use to initiate the service. The UE 102 may attempt the preferred network first. In case of failure, the UE 102 may not be able to initiate the service even though alternatives would be available. Furthermore, the core network 120 providing the IP connectivity and the IMS core network offering the services are independent network layers, and therefore domain selection for the UE 102 may not be dynamically supported.

For instance, a UE 102 registered on IMS over LTE may initiate a voice call over IMS. If the IMS network is consistently rejecting the IMS call for any IMS-internal reason, the UE 102 may not be able to initiate the call, even though a CS network is available and can be used instead. Additionally, similar issues can occur if the core network 120 (e.g., EPC network) is not able to establish the dedicated EPS bearer, which can result in the IMS call not being set up even though the IMS network layer may be working.

Moreover, in case of emergency service, the UE 102 may retry on another domain. However, such mechanism may be not efficient either. The criteria for domain selection for emergency calls can mainly be based on the CS or EPS core network, but not on the IMS core network criteria. The emergency call setup may, however, fail for reasons independent of the EPS network.

For example, the emergency call setup may fail because the IMS network may not allow the user to setup IMS emergency calls, the IMS network policy can be to redirect emergency calls to CS domain, the IMS network may not accept users who are not registered via the regular procedures, the positioning information may not be compliant with local regulatory rules, the device may not support the positioning method, or because of other reasons.

In some instances, the selection criteria can indicate IMS as primary domain, but the emergency call can fail and have to be retried on CS domain. The initial attempt via IMS can be a waste of network resources and also delays the emergency call setup time. The setup time can be delayed because before being able to setup an emergency call over IMS, the device may first have to set up an emergency PDP/EPS context, and then perform an IMS emergency registration along with positioning information exchange, if requested by the network. If call set up via the IMS fails, the UE 102 will have to select a CS capable cell and attempt again the emergency call on CS domain. Additionally, the congestion of network resources can be amplified in case of large emergency situations (e.g., earthquakes).

Additionally, the lack of coordination between the different access or core networks (e.g., core network 120) and the lack of assistance from the network to the device in the domain selection procedure can have multiple drawbacks.

The drawbacks for users can include service denial and long service setup time. The long service setup time can be due to the domain switch (e.g., EPS bearer setup, Session Initiation Protocol (SIP) signaling, reselection to CS network, CS setup signaling, etc.). Due to the long delay to set up the call, the user may, in the meantime, abort the procedure and restart again in the primary domain, creating even more delay and signaling load.

The drawbacks for the network can include additional consumption of resources due to multiple service setup signaling on IMS and CS domains, and additional resources wasted in case the user aborts the call then retries again due to a long setup time.

Various embodiments disclosed herein may improve service domain selection on the device side based on network assistance. The network assistance may be based on the analysis of information related to device location and related domain information (e.g., IMS domain, CS domain, or any other future service network), device information, and service failure cause.

In some embodiments, a new signaling approach is introduced between the devices (e.g., UE 102) and the network (e.g., RAN 100) to exchange service failure information from the UE 102 to the RAN 100 as well as domain selection assistance information from the RAN 100 to UE 102.

In some instances, the UE 102 can inform a diagnostic and assistance server about service setup failures by generating domain selection assistance information (DSAI). Additionally, the UE 102 can transmit the DSAI to the diagnostic and assistance server. The DSAI can include the cause of the failure (e.g., failure at radio access level, EPS connection setup, IMS call signaling, CS call signaling). Moreover, the DSAI can include the current location (e.g., Public Land Mobile Network (PLMN) and tracking/routing/location area, cell identity), the selected domain (e.g., IMS, CS), and other information (e.g., home operator identity, UE identity).

Subsequently, the diagnostic and assistance server can gather the DSAI received from multiple UEs 102 in order to identify a problem and the responsible network component (e.g., IMS, EPC, etc.). For example, if a persistent failure is identified in a specific location area, the diagnostic and assistance server may inform, using domain assistance selection data (DSAD), the UEs 102 present in this location area about an alternative domain to use to initiate a specific service. The UEs 102 may then use this alternative domain as first priority in their domain selection process when initiating the service.

Additionally, the diagnostic and assistance server in charge of this functionality to gather information and provide DSAD can either be part of one or more existing core network components (e.g., RAN 100, core network 120) or be a new network component.

Moreover, the information (e.g., DSAI, DSAD) exchange between the device and the network entity can be performed using an IP connection, non-access stratum (NAS) signaling, or access stratum (AS) signaling.

Furthermore, based on device feedback, the diagnostic and assistance server can be able to correlate causes of failure between multiple core networks and may consequently proactively and dynamically support the device in the domain selection process.

For example, the UE 102 can include processing circuitry to initiate the service for a service type using a current domain. Additionally, the UE 102 can detect a service initiation failure for the service. Moreover, the UE 102 can generate domain selection assistance information (DSAI) based on the detected service initiation failure. The DSAI can include the service type and the current domain. Furthermore, the UE 102 can include transceiver circuitry to send the DSAI to a network entity. The network entity can be a diagnostic and assistance server, which can be part of the eNB 104 or MME 122. The sending of the DSAI can be configured to assist the diagnostic and assistance server in selecting a preferred domain for the service type when the UE 102 initiates a new service.

The techniques described herein can reduce denial of service, reduce latency, reduce service setup time, improve network usage, improve network diagnostic capabilities, and enable network load balancing. For example, the denial of service cases can be reduced using a dynamic indication of alternative domains by the network. The latency and service setup time can be reduced since the device is able to initiate the service to the right domain without a retry mechanism. The network resource usage can be improved due to reduced signaling by avoiding service retry on the secondary domain. The network diagnostic capabilities can be improved, especially when multiple independent core networks are used.

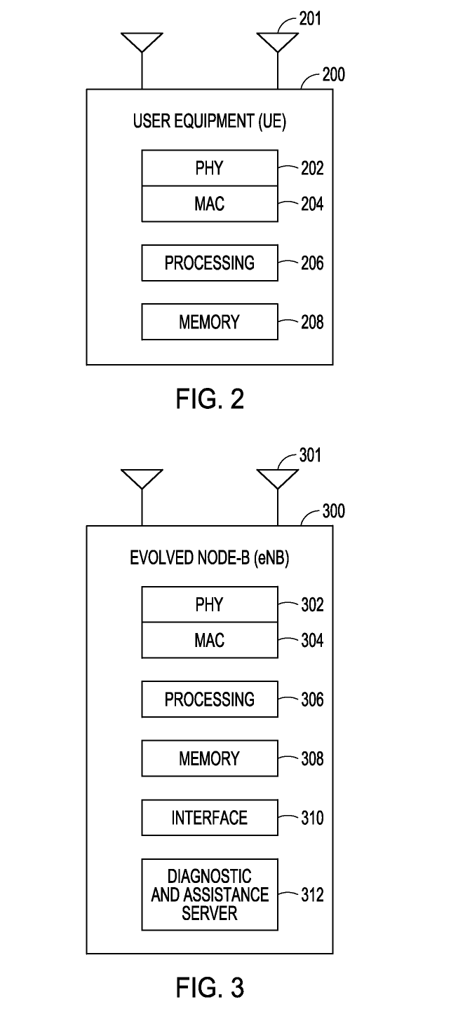

FIG. 2 is a functional diagram of a UE 200, in accordance with some embodiments. FIG. 3 is a functional diagram of an evolved node-B (eNB) 300, in accordance with some embodiments. In some instances, the eNB 300 may be the eNB 104 as depicted in FIG. 1. The UE 200 may be a UE 102 as depicted in FIG. 1.

The eNB 300 can include a diagnostic and assistance server 312. In some instances, the diagnostic and assistance server may be part of the eNB 104 as depicted in FIG. 1. Alternatively, the diagnostic and assistance server may be part of the MME 122 as depicted in FIG. 1.

The UE 200 may include physical layer circuitry 202 for transmitting and receiving signals to and from the eNB 300, other eNBs, other UEs, or other devices using one or more antennas 201, while the eNB 300 may include physical layer circuitry 302 for transmitting and receiving signals to and from the UE 200, other eNBs, other UEs, or other devices using one or more antennas 301. The UE 200 may also include medium access control layer (MAC) circuitry 204 for controlling access to the wireless medium, while the eNB 300 may also include MAC circuitry 304 for controlling access to the wireless medium. The UE 200 may also include processing circuitry 206 and memory 208 arranged to perform the operations described herein, and the eNB 300 may also include processing circuitry 306 and memory 308 arranged to perform the operations described herein. The eNB 300 may also include one or more interfaces 310, which may enable communication with other components, including other eNBs 104 (FIG. 1), components in the core network 120 (FIG. 1), or other network components. In addition, the interfaces 310 may enable communication with other components that may not be shown in FIG. 1, including components external to the network. The interfaces 310 may be wired, wireless, or a combination thereof.

The antennas 201, 301 may comprise one or more directional or omnidirectional antennas, including, for example, dipole antennas, monopole antennas, patch antennas, loop antennas, microstrip antennas, or other types of antennas suitable for transmission of radio frequency (RF) signals. In some multiple-input multiple-output (MIMO) embodiments, the antennas 201, 301 may be effectively separated to take advantage of spatial diversity and the different channel characteristics that may result.

The diagnostic and assistance server 312 can interface with other components of the eNB 300 (e.g., e antenna 301, PHY 302, and MAC 304) to communicate with the UE 102 via a radio interface. Additionally, the diagnostic and assistance server can have processing circuitry, memory and interfaces to communicate with the other components of the eNB 300 via one or more internal interfaces.

In some embodiments, mobile devices or other devices described herein may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or another device including wearable devices that may receive and/or transmit information wirelessly. In some embodiments, the mobile device or other device can be a UE or an eNB configured to operate in accordance with 3GPP standards. In some embodiments, the mobile device or other device may be configured to operate according to other protocols or standards, including IEEE 802.11 or other IEEE standards. In some embodiments, the mobile device or other device may include one or more of a keyboard, a display, a non-volatile memory port, multiple antennas, a graphics processor, an application processor, speakers, and other mobile device elements. The display may be a liquid crystal display (LCD) screen including a touch screen.

Although the UE 200 and the eNB 300 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

Embodiments may be implemented in one or a combination of hardware, firmware, and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors that may be configured with instructions stored on a computer-readable storage device.

In some embodiments, the UE 200 may be configured to receive OFDM communication signals over a multicarrier communication channel in accordance with an OFDMA communication technique. The OFDM signals may comprise a plurality of orthogonal subcarriers. In some broadband multicarrier embodiments, the eNB 300 may be part of a broadband wireless access (BWA) communication network, such as a Worldwide Interoperability for Microwave Access (WiMAX) communication network, a 3GPP Universal Terrestrial Radio Access Network (UTRAN) LTE network, or a LTE communication network, although the scope of this disclosure is not limited in this respect. In these broadband multicarrier embodiments, the UE 200 and the eNB 300 may be configured to communicate in accordance with an OFDMA technique.

### LTE Architecture for Service Initiation

In some instances, upon service initiation failure, the UE 102 can send to the network entity (e.g., diagnostic and assistance server 312) DSAI related to the service failure. The list of information can include a location of the device, attempted service (e.g., voice call, SMS), a cause of failure (e.g., SIP failure with corresponding cause, EPS failure), and a domain selection related parameter.

For example, the location of the UE 102 can include a registered PLMN (RPLMN), a visited PLMN (VPLMN), a tracking area code, a routing area code (RAC), or a location area code (LAC). Additionally, the domain selection related parameter can include a PS registration status, a CS registration status, an IMS registration status, an emergency bearer support from EPS network, an IMS voice support from EPS network, a voice domain preference, or a usage setting (e.g., voice-centric, or data-centric) for a UE 102.

In some instances, some of the DSAI can be accessed from other network entities (e.g., IMS registration status, emergency bearer support from network, etc.), instead of being sent by the UE 102 to the diagnostic and assistance server 312, which results in reduced signaling over the air. However, in some cases, it may be useful to also receive the status stored at the UE 102. For example, it may be possible for the UE 102 and the other network entities to be out-of-sync (e.g., regarding the IMS registration status).

Additionally, the DSAI can include the International Mobile Station Equipment Identity (IMEI) and Software Version Number (IMEISV) of the UE, which can be in an anonymized form for privacy reasons (for example, the individual serial number of the device can be replaced with a fixed bit pattern). The IMEI can be used by the diagnostic and assistance server 312) to check whether the problem is occurring only with a specific type of device, which can then be used to determine that the service failure is due to a UE problem rather than a network problem.

In case of service retry, the UE 102 can also inform the diagnostic and assistance server 312 about the service retry and on which domain it was initiated. The UE 102 may also inform the diagnostic and assistance server 312 if an alternative IP connection is used (e.g., such as IMS over WLAN instead of IMS over EPS).

The UE 102 can either connect to a remote server based on an IP connection, NAS signaling (e.g., NAS transport signaling message), or AS signaling (e.g., the Radio Resource Control (RRC) message UEInformationResponse). Additionally, if IP-based, the connection can be secured with existing security procedures.

Next, the diagnostic and assistance server 312 can collect inputs from all connected devices. For privacy reasons, the subscriber may have the option to configure the UE 102 to not participate in this data collection. The diagnostic and assistance server 312 may identify repetitive issues and identify the network component responsible. The cause of the failure may be restricted to one location area, routing area, tracking area, or a single cell. Additionally, if a repetitive failure is detected in the area, the diagnostic and assistance server 312 can inform all devices located in this area about the preferred domain to use. This indication, also referred as the domain selection assistance data (DSAD), can be for one or multiple types of service (e.g., voice call, video call, SMS, etc.). The failure may also be specific to a group of users (e.g., in case of roaming, the failure may be related to all users from a specific home operator).

Additionally, the diagnostic and assistance server 312 may inform the UEs 102 within a failure area about a preferred domain to be used, or about different preferred domains to be used by the UEs 102. For example, different domains can be indicated to better balance the load between the different domains.

The diagnostic and assistance server 312 can also combine the data accessed by a network-proprietary failure detection system with the data provided by the UE 102 via standardized signaling. Alternatively, the diagnostic and assistance server 312 can collect data only via the network proprietary failure detection system. For example, the failure diagnostics information can be only collected from a subset of the operator's own subscribers, whereas the DSAD can then be provided to all UEs 102 registered in the network via standardized signaling. The diagnostic and assistance server 312 may provide the DSAD based on an IP connection or based on NAS signaling.

For some specific services, such as emergency calls, the DSAD can also be broadcast in system information (e.g., via AS signaling). For example, in case of large emergency situations, a system information broadcast can reach more devices with less resource consumption. If the RAN 100 is shared by several core network operators (e.g., different core networks are connected to the same RAN node), it may also be possible to signal, in the system information broadcast, different DSAD for each core network 120.

In some instances, the UE 102 can transmit a request to the diagnostic and assistance server 312 for a recommended domain. The diagnostic and assistance server 312 may also use the request to redirect devices from one domain to another domain for load balancing purposes.

In some instances, the diagnostic and assistance server 312 in the network responsible for a particular UE 102 can belong to the home operator's network or to the visited operator's network.

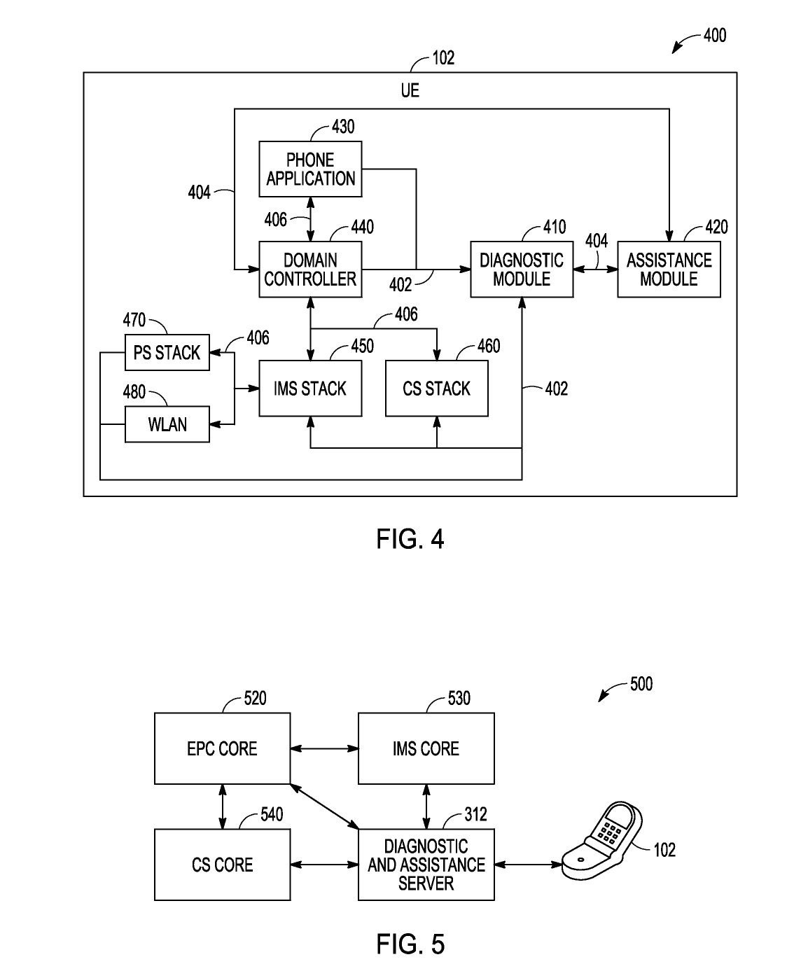

FIG. 4 illustrates a flow diagram of components of a UE (e.g., UE 102, UE 200), in accordance with some embodiments. The UE 102 can include a diagnostic module 410 and an assistance module 420. In some instances, a diagnostic module 410, using processing circuitry 206 of FIG. 2, can gather diagnostic information to determine the preferred domain. Additionally, an assistance module 420 can assist a domain controller 440 in a service setup by using processing circuitry 206 of FIG. 2.

At operation 402, diagnostic information (e.g., DSAD, service failure, and related parameters) can be received by the diagnostic module 410 of UE 200. For example, the diagnostic module 410 can receive diagnostic information from a phone application 430, the domain controller 440, an IMS stack 450, a CS stack 460, a PS stack 470, and a WLAN 480. Additionally, the diagnostic module 410 can receive the DSAD from the diagnostic and assistance server 312).

At operation 404, the diagnostic module 410, using the received diagnostic information (e.g., DSAD), can determine a preferred domain to initiate a new service. Additionally, the diagnostic module 410 can communicate the preferred domain determination to the assistance module 420. In some instances, the diagnostic information can also be sent to the assistance module 420. Furthermore, the assistance module 420 can register to the diagnostic and assistance server 312 to provide the service failure notification (e.g., DSAI). Moreover, the assistance module 420 can also receive assistance information (e.g., DSAD) from the diagnostic and assistance server 312 and provide the assistance information to the domain controller 440.

At operation 406, the domain controller 440 can determine which domain to setup a service on based on the assistance information received at operation 404. The domain controller 440 can communication with the phone application 430, the IMS stack 450, and the CS stack 460 for the service setup. Additionally, the IMS stack 450 can communicate with the PS stack 470 and the WLAN 480 for the service setup.

FIG. 5 illustrates an example of a scenario 500 of the diagnostic and assistance server 312 in a 3GPP network, in accordance with some embodiments. As previously discussed, FIG. 1 is a functional diagram of a 3GPP network. Additionally, the diagnostic and assistance server 312 can be embedded in one or more of the existing network components of FIG. 1 (e.g., eNB 104, MME 122). Alternatively, the diagnostic and assistance server 312 can be a separate component. In some instances, the core network 120 of FIG. 1 can include the EPC core 520, IMS Core 530, or CS core 540.

The diagnostic and assistance server 312 can exchange diagnostic and assistance information with a device, such as UE 102 of FIG. 1. The information can be exchanged using an IP connection, NAS signaling, or AS signaling.

In the IP connection example, the UE 102 can first establish a Transmission Control Protocol (TCP) or User Datagram Protocol (UDP) connection to the diagnostic and assistance server 312. In some instances, the UE can first register with the diagnostic and assistance server 312 before establishing the TCP or UDP connection. Additionally, the connection can be secured using well known security methods. The address of the diagnostic and assistance server 312 can either be provisioned within the UE 102 or retrieved by the UE 102. For example, the address can be retrieved using a protocol configuration option (PCO) when setting up a PDP or PDN connection.

In the NAS signaling example, the diagnostic and assistance information can be exchanged by routing through the MME 122, the SGSN, or the mobile switching center (MSC). Additionally, the diagnostic and assistance information can include a generic NAS transport message that can be reused for transfer via the MME 122.

In the AS signaling example, the diagnostic and assistance information can be routed to the diagnostic and assistance server 312 through the BSC, RAN 100 (e.g., RNC), or eNB 104. In some instances, some of the diagnostic and assistance information (e.g., assistance information) can be provided via system information broadcast. Additionally, a ‘UEInformationResponse’ message can be reused for transfer from the UE 102 to the eNB 104.

Any of the above options described in FIG. 5 can be combined as suitable for the transfer of data between the UE 102 and the diagnostic and assistance server 312. Additionally, the diagnostic and assistance server 312 can communicate with an EPC core 520, IMS Core 530, or CS core 540.

### Example Communications Between the UE and the Diagnostic Server

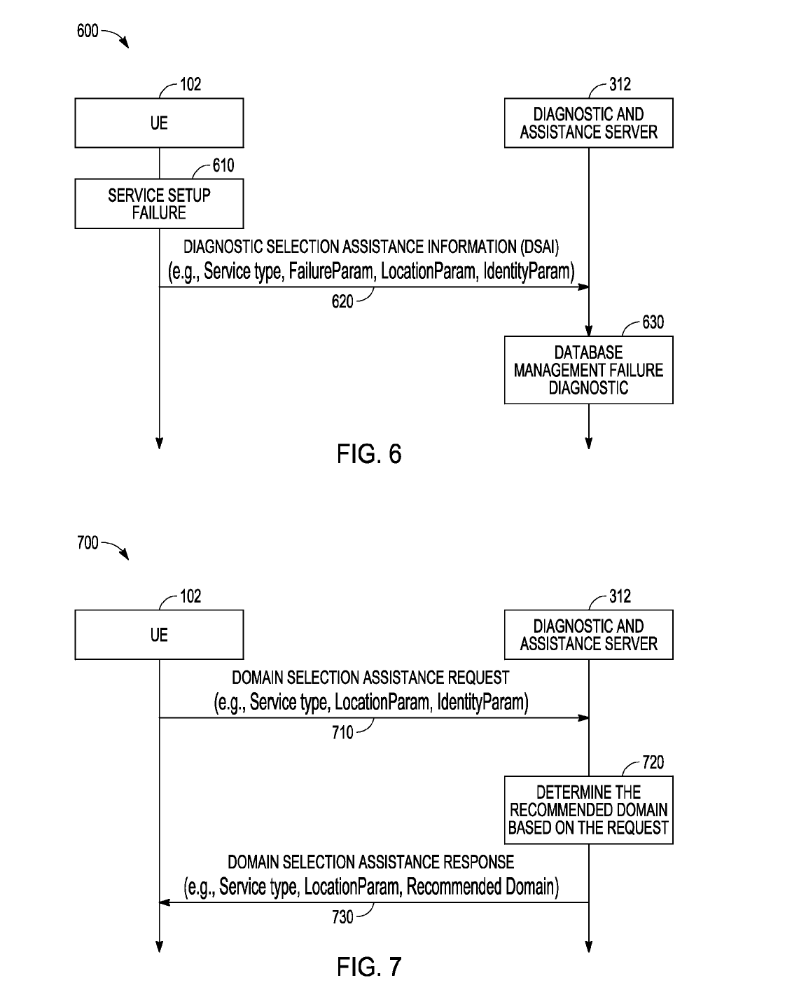

FIG. 6 illustrates an example of a communication 600 between a UE 102 and a diagnostic and assistance server 312 during a service setup failure notification, in accordance with some embodiments.

In some instances, when a service setup failure 610 occurs, the UE 102 can transmit diagnostic selection assistance information (DSAI) 620 to the diagnostic and assistance server 312. The notification can include a service type, failure cause, location parameters, a device identifier, or other relevant information.

Subsequently, the diagnostic and assistance server 312 can gather notifications from all devices. Additionally, by analyzing the received notifications, the diagnostic and assistance server 312 can detect temporary or persistent failures either for multiple devices or for a single device in a location area. The detection of a failure can be included in a database management failure diagnostic 630 performed by the diagnostic and assistance server 312.

FIG. 7 illustrates an example of a communication 700 between a UE 102 and a diagnostic and assistance server 312 during an assistance request, in accordance with some embodiments.

In some instances, when entering a new location area, routing area, or tracking area, the UE 102 may proactively request a domain selection recommendation. Additionally, during a periodic location, routing, or tracking area update procedure, the UE 102 may proactively request a domain selection recommendation. The request can be a domain selection assistance request 710 that includes a service type, a location parameter, an identity parameter, and other relevant information.

At operation 720, the diagnostic and assistance server 312 can determine the recommended domain based on the request. Subsequently, the diagnostic and assistance server 312 can transmit a domain selection assistance response 730 including DSAD to the UE 102. The domain selection assistance response 730 can include a service type, a location parameter, a recommended domain, or other relevant information.

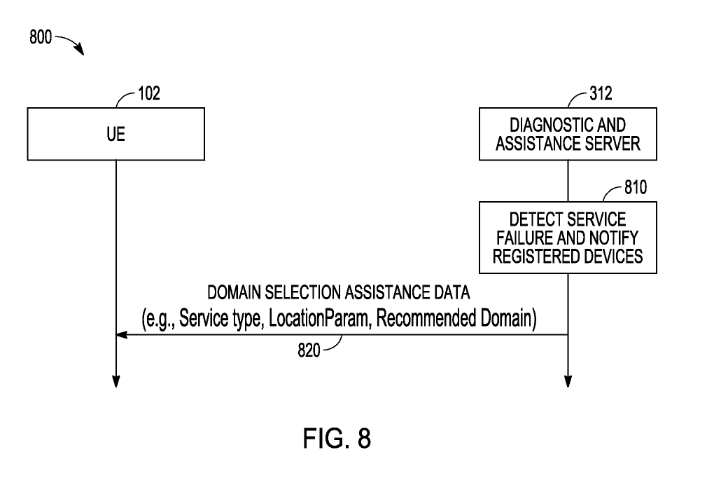

FIG. 8 illustrates an example of a communication 800 between a UE 102 and a diagnostic and assistance server 312 during an assistance notification, in accordance with some embodiments.

In some instances, if some persistent failures are detected on a domain and on a specific area or for a specific group of users, the diagnostic and assistance server 312 can notify all the registered devices at operation 810. The notification can be provided via dedicated connections or via system information broadcast.

In some instances, failure can be detected in a determined location area or for a specific group of users. In such instances, the notification may only be sent to the UEs 102 in the determined location area, or to the specific group of users.

The notification can be a domain selection assistance data (DSAD) 820, which can include a service type, a location parameter, a recommended domain, or other relevant information.

### Emergency Call Setup Failure Example

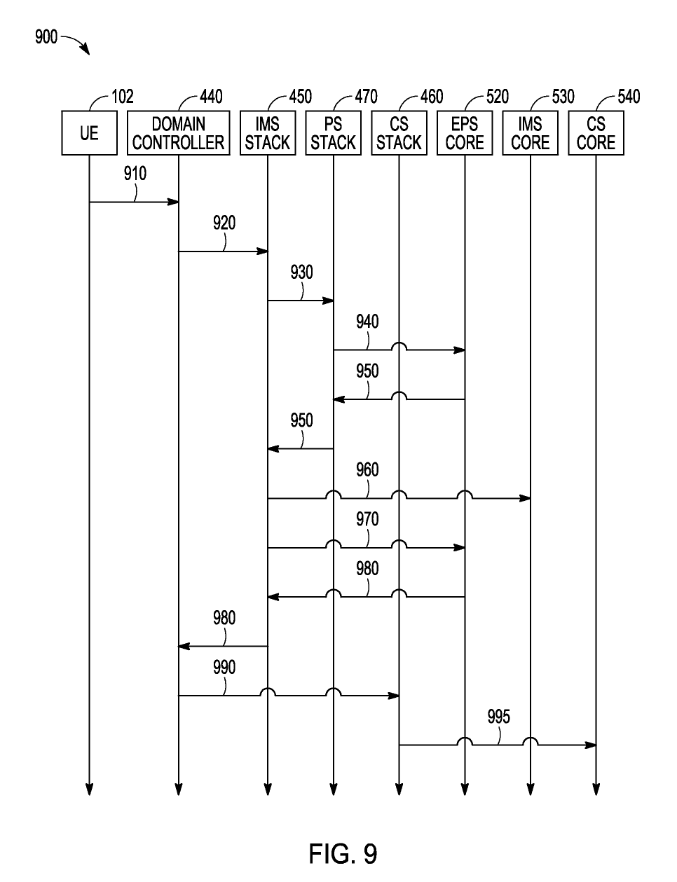

FIG. 9 illustrates a scenario 900 of an emergency call setup failure on an IMS domain followed by a retry on a CS domain, in accordance with some embodiments.

In current implementations, during an emergency call setup, a UE 102 can initiate an emergency call to a domain controller 440 at operation 910. At operation 920, the domain controller 440 can request an emergency call to an IMS stack 450. The IMS stack 450 can send an emergency PDN connection request to a PS stack 470 at operation 930. Then, the PS stack 470 can the request EPC core 520 to setup emergency PDN connection, at operation 940.

Once the emergency PDN connection is successfully established, the confirmation is sent from the EPC core 520 to PS stack 470, and then the confirmation is sent from the PS stack 470 to the IMS stack 450, at operation 950. Subsequently, the IMS stack 450 performs IMS registration with IMS core 530, at operation 960. Then the IMS stack 450 initiates SIP INVITE (e.g., emergency call setup request) with the EPS core 520, at operation 980. In some instances, the failure happen can occur at this level, and a rejection is sent from the EPS core 520 to the IMS stack 450, and then domain controller, at operation 980.

Based on the received rejection, the domain controller 440 can retry the emergency call on the CS domain. At operation 990, the domain controller 440 can sent an emergency call request to the CS stack 460. The CS stack 460 can initiate a circuit switch fallback, or reselect directly a CS capable cell. At operation 995, the CS stack 460 can sent the emergency call request to a CS core 540 in order to successfully initiate the emergency call.

The scenario 900 is an example of emergency call setup and failure over IMS domain and retry over CS domain. The scenario 900 illustrates the different signaling phases to be performed in current implementation. In contrast, using the techniques described herein, the domain controller 440, using the DSAD 820, can directly initiate the emergency call over the CS domain, hence reducing call setup time and reducing network load.

### Domain Selection Using ANDSF

In some embodiments, domain selection can be influenced by way of operator policies using the ANDSF or other such Management Object (MO). The ANDSF can be an entity within the EPC core 520 for 3GPP compliant mobile networks.

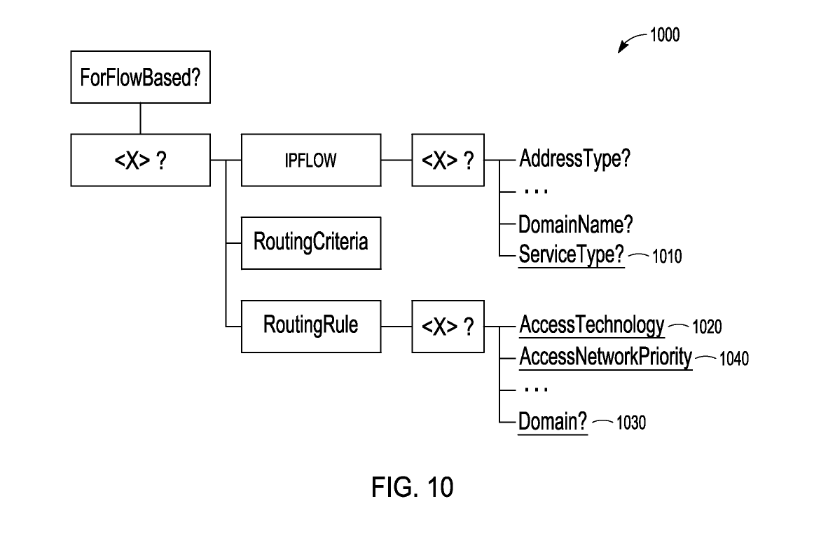

FIG. 10 illustrates some of the parameters in the ANDSF MO, in accordance with some embodiments. For example, the ANDSF MO parameters 1000 can include a new parameter, such as a service type parameter 1010 (e.g., <ServiceType>). The service type parameter 1010 can identify the different types of services (e.g., emergency, voice, video, SMS, etc.). The UE 102 or the domain controller 440 can determine the preferred domain. For example, the preferred domain can be determined by searching a service type parameter matching the service requested by the user and using the service type appropriate routing rules to initiate a service based on the service type parameter.

Additionally, the ANDSF MO can further include an access technology parameter 1020 (e.g., <AccessTechnology>). The access technology parameter 1020 can include different 3GPP access (e.g., E-UTRAN, UTRAN, GSM Enhanced Data Rates for GSM Evolution (EDGE) Radio Access Network (GERAN)), and different non-3GPP accesses (e.g., WLAN).

Alternately, the ANDSF MO can include a domain parameter 1030 (e.g., <Domain>). The domain parameter 1030 can specify over which domain (e.g., CS, PS, or IMS) to route the traffic.

In some instances, the AccessNetworkPriority 1040 of the ANDSF MO can define the priority level depending on ongoing network conditions applicable for a specific application (e.g., IP flow) or service and the specific access technology. The priority level based on a parameter can be extended to other nodes in the ANDSF MO as well.

According to other embodiments, the domain preferences as described above with regards to the ANDSF MO can be applied to the “For NonSeamlessOffload” Inter System Routing Policy (ISRP) rules, the Inter Access Point Name (APN) routing policies, and to the Inter-system Mobility Policies (ISMP).

Furthermore, the Unstructured Supplementary Services Data (USSD) Simulation in IMS (USSI) MO can be used to manage settings of the UE 102 for USSI. The USSI MO covers configuration parameters for a UE that supports the USSI capabilities specified, for example, in 3GPP TS 24.390. In yet another variant, the domain preferences described above can be added to the USSI MO.

### Techniques for Initiating a Service

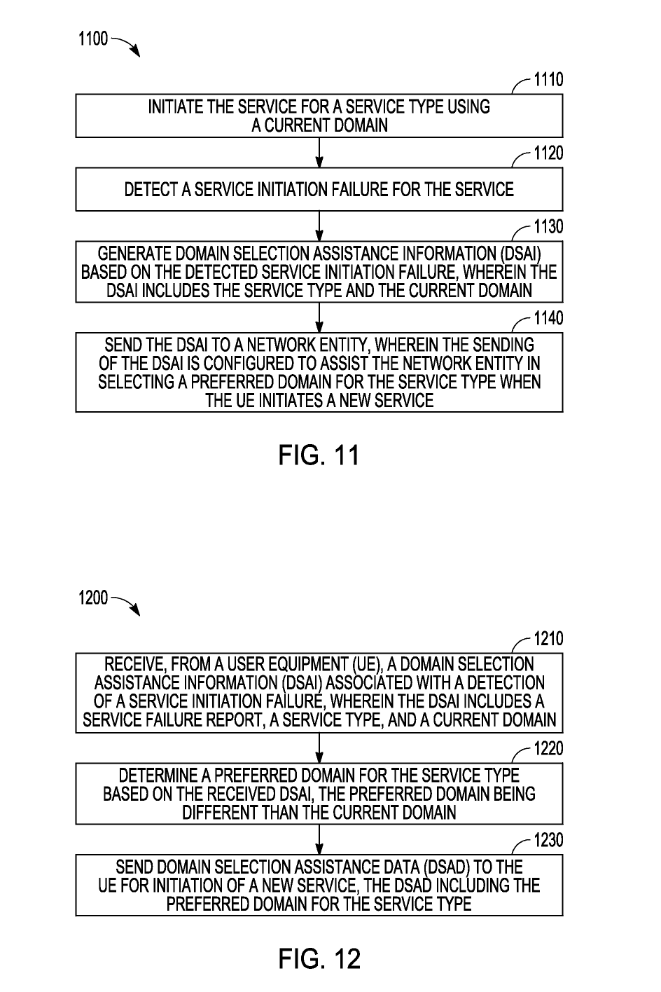

FIG. 11 illustrates the operation of a method 1100 for initiating a service in a mobile communication network and providing using DSAI, in accordance with some embodiments. Method 1100 can be performed by a UE (e.g., UE 102, UE 200). Embodiments are not limited to these configurations, however, and some or all of the techniques and operations described herein may be applied to any systems or networks.

It is important to note that embodiments of the method 1100 may include additional or even fewer operations or processes in comparison to what is illustrated in FIG. 11. In addition, embodiments of the method 1100 are not necessarily limited to the chronological order that is shown in FIG. 11. In describing the method 1100, reference may be made to FIGS. 1-10, although it is understood that the method 1100 may be practiced with any other suitable systems, interfaces, and components.

In addition, while the method 1100 and other methods described herein may refer to eNBs 104 or UEs 102 operating in accordance with 3GPP or other standards, embodiments of those methods are not limited to just those eNBs 104 or UEs 102 and may also be practiced by other mobile devices, such as a Wi-Fi access point (AP) or user station (STA). Moreover, the method 1100 and other methods described herein may be practiced by wireless devices configured to operate in other suitable types of wireless communication systems, including systems configured to operate according to various IEEE standards such as IEEE 802.11.

At operation 1110 of the method 1100, the UE 102, using processing circuitry, can initiate a service for a service type using a current domain. For example, the current domain can be a CS domain or a PS domain. Additionally, the service type can be a voice call, a video call, or a SMS. In some instances, the processing circuitry can be the processing circuitry 206 of UE 200 in FIG. 2.

At operation 1120, the UE 102, using the processing circuitry, can detect a service initiation failure for the initiated service from operation 1110. For example, in FIG. 6, the UE 102 can detect a service setup failure 610. As previously mentioned, the processing circuitry can be the processing circuitry 206 of UE 200 in FIG. 2.

At operation 1130, the UE 102, using the processing circuitry, can generate DSAI (e.g., DSAI 620) based on the detected service initiation failure. The DSAI 620 can include the service type and the current domain from operation 1110. For example, in FIG. 6, the DSAI 620 includes a service type parameter and a current domain. As previously mentioned, the processing circuitry can be the processing circuitry 206 of UE 200 in FIG. 2.

In some instances, the DSAI can includes an access technology (e.g., LTE, WLAN), as described in FIG. 10.

In some instances, the DSAI can include a location of the UE 102. For example, in FIG. 6, the DSAI 620 includes a location parameter (e.g., ‘LocationParam’).

In some instances, the DSAI 620 can include a cause of failure. For example, in FIG. 6, the DSAI 620 includes a failure parameter (e.g., ‘FailureParam’).

In some instances, the DSAI 620 can include a domain selection related parameter, such as a PS/CS registration status or IMS registration status.

Continuing with method 1100, at operation 1140, the UE 102, using transceiver circuitry, can send the DSAI 620 to a network entity. The network entity can be the diagnostic and assistance server 312.

Additionally, the sending of the DSAI 620 can be configured to assist the network entity in selecting a preferred domain for the service type when the UE initiates a new service. For example, the network entity can assist in selecting a preferred domain by sending the DSAD 820 to the UE 102, as described in FIG. 12. In some instances, the transceiver circuitry can be the physical layer circuitry 202 of UE 200 in FIG. 2.

In some instances, the network entity can be a configuration server for MO. For example, the configuration server can be an ANDSF server within an EPC. As previously described, FIG. 10 illustrates examples of the ANDSF parameters 1000 (e.g., a service type parameter 1010, access technology parameter 1020, domain parameter 1030), which can be used by the UE 102 or the domain controller 440 to determine the preferred domain to initiate a service.

In some instances, the DSAI 620 can be sent to a network entity at operation 1140 using the NAS level. Alternatively, the DSAI 620 can be sent to the network entity using the AS level.

In some instances, the transceiver circuitry of method 1100 can be configured to receive, from the network entity, the preferred domain for the service type, the preferred domain being different than the current domain. As previously described, the domain selection assistance response 730 of FIG. 7 and the domain selection assistance data 820 of FIG. 8 are examples of the preferred domain (e.g., ‘Recommended Domain’) being sent to the UE 102. Additionally, the processing circuitry can be further configured to initiate the new service for the service type using the preferred domain. For example, the current domain can be a CS domain, and the preferred domain is a PS domain. Alternatively, the current domain can be a PS domain, and the preferred domain can be a CS domain. Additionally, the PS domain can be accessed using LTE, HSPA, or WLAN.

In some instances, the processing circuitry of method 1100 can be configured to generate a service failure report. Additionally, the transceiver circuitry can be further configured to send the service failure report to a MME (e.g., MME 122) or an eNB (e.g., eNB 104). Furthermore, the service failure report can be sent using an IP connection, where the IP connection is secured with security procedures.

FIG. 12 illustrates the operation of a method 1200 for assisting in a new service initiation in a mobile communication network, in accordance with some embodiments. Method 1200 can be performed by a diagnostic and assistance server 312 which can be a separate component or be embedded in an eNB (e.g., eNB 104), a MME (e.g., MME 122), a SGSN, or a MSC. Additionally, method 1200 can be performed by the eNB 300 having a diagnostic and assistance server 312. It is important to note that embodiments of the method 1200 may include additional or even fewer operations or processes in comparison to what is illustrated in FIG. 12. In addition, embodiments of the method 1200 are not necessarily limited to the chronological order that is shown in FIG. 12. In describing the method 1200, reference may be made to FIGS. 1-11, although it is understood that the method 1200 may be practiced with any other suitable systems, interfaces, and components.

In addition, while the method 1200 and other methods described herein may refer to the diagnostic and assistance server 312 or UEs 102 operating in accordance with 3GPP or other standards, embodiments of those methods are not limited to just those the diagnostic and assistance server 312 or UEs 102 and may also be practiced by an eNB 104, a MME 122, or other mobile devices, such as a Wi-Fi AP or STA. Moreover, the method 1200 and other methods described herein may be practiced by wireless devices configured to operate in other suitable types of wireless communication systems, including systems configured to operate according to various IEEE standards such as IEEE 802.11.

The method 1200 can be performed by the diagnostic and assistance server 312 configured to assist in initiating a new service initiation in a mobile communication network.

At operation 1210, the diagnostic and assistance server 312 can include processing circuitry to receive from a UE (e.g., UE 102) domain selection assistance information (DSAI) associated with a detection of a service initiation failure. The DSAI 620 includes a service failure report, a service type, and a current domain. Method 1100 of FIG. 11 illustrates example of the UE 102 sending a DSAI 620 to the diagnostic and assistance server 312. The processing circuitry of the diagnostic and assistance server 312 for performing operations 1210 and 1220 can be similar to the processing circuitry 306 in FIG. 3. In some instances, the processing circuitry can be included in the diagnostic and assistance server 312.

In some instances, some of the DSAI 620 can be accessed by the diagnostic and assistance server 312 or eNB 300 from other network entities (e.g., IMS registration status, emergency bearer support from network), instead of being sent by the UE 102 to the diagnostic and assistance server 312, which results in reduced signaling over the air.

At operation 1220, the diagnostic and assistance server 312 can determine a preferred domain for the service type based on the received DSAI 620. The preferred domain can be different than the current domain. For example, operation 720 of FIG. 7 illustrates an example of this determination.

At operation 1230, the diagnostic and assistance server 312 can include an interface to send domain selection assistance data (DSAD) to the UE 102 for initiation of a new service. The DSAD 820 can include the preferred domain for the service type. The interface of the diagnostic and assistance server 312 for performing operations 1230 can be similar to the interface 310 in FIG. 3. In some instances, the interface can be included in the diagnostic and assistance server 312.

The interface for performing operation 1230 can interface with other components (e.g., the antenna 301, the PHY 302, and MAC 304) of the eNB 300 to communicate with the UE 102 via a radio interface.

In some instances, the diagnostic and assistance server of method 1200 can be part of an eNB (e.g., eNB 104). Alternatively, the diagnostic and assistance server of method 1200 can be part of a Mobility Management Entity (e.g., MME 122).

In some instances, the interface at operation 1230 can be further configured to send a timer value to the UE 102. Additionally, the UE can only initiates the new service using the preferred domain if the timer value has not expired. For example, the eNB 104 can send to the UE 102 a preferred domain to be used in the next hour. After the time value has expired, the UE 102 can initiate the new service using the current domain.

In some instances, the interface at operation 1230 can be further configured to send a location area. Additionally, the UE 102 can initiate the new service using the preferred domain if the UE is within the location area. Alternatively, when the UE 102 is not within the location area, the UE 102 can initiate the new service using the current domain.

In some instances, the interface can be further configured to send the preferred domain for the service type using an IP connection. The IP connection can be secured with security procedures.

According to some embodiments, the method 1200 as described above can be performed by the eNB 104. Additionally, according to another embodiment, the method 1200 can be performed by the MME 122 or the SGW 124.

### Examples

Example 1 is a method for an apparatus of a UE (e.g., UE 102) for initiating a service in a mobile communication network, the apparatus comprising: processing circuitry to: initiate the service for a service type using a current domain; detect a service initiation failure for the service; and generate domain selection assistance information (DSAI) based on the detected service initiation failure, wherein the DSAI 620 includes the service type and the current domain; and transceiver circuitry to send the DSAI 620 to a network entity, wherein the sending of the DSAI 620 is configured to assist the network entity in selecting a preferred domain for the service type when the UE initiates a new service.

Example 2 includes the apparatus of Example 1, wherein the transceiver circuitry is further configured to: receive, from the network entity, the preferred domain for the service type, the preferred domain being different than the current domain; and wherein the processing circuitry is further configured to initiate the new service for the service type using the preferred domain.

Example 3 includes the apparatus of the above examples, wherein the current domain is a circuit switched (CS) domain, and the preferred domain is a packet switched (PS) domain.

Example 4 includes the apparatus of the above examples, wherein the preferred domain is accessed using Long Term Evolution (LTE), High Speed Packet Access (HSPA), or Wireless Local Area Network (WLAN).

Example 5 includes the apparatus of the above examples, wherein the service type is a voice call, a video call, or a short messaging service (SMS).

Example 6 includes the apparatus of the above examples, wherein in response to the detected service initiation failure, the processing circuitry is further configured to re-initiate the service for the service type using an updated domain; and wherein the DSAI further includes the updated domain.

Example 7 includes the apparatus of the above examples, wherein the DSAI further includes an access technology.

Example 8 includes the apparatus of the above examples, wherein the DSAI further includes a location of the UE.

Example 9 includes the apparatus of the above examples, wherein the DSAI further includes a cause of failure.

Example 10 includes the apparatus of the above examples, wherein the DSAI further includes a domain selection related parameter.

Example 11 includes the apparatus of Examples 1-10, wherein the network entity is a configuration server with a management object (MO).

Example 12 includes the apparatus of Examples 1-10, wherein the configuration server is an access network discovery and selection function (ANDSF) server within an evolved packet core (EPC).

Example 13 includes the apparatus of Examples 1-12, wherein the DSAI is sent to the network entity using a non-access stratum (NAS) level.

Example 14 includes the apparatus of Examples 1-12, wherein the DSAI is sent to the network entity using an Access Stratum (AS) level.

Example 15 includes the apparatus of the above examples, wherein the processing circuitry is further configured to: generate a service failure report; and wherein the transceiver circuitry is further configured to send the service failure report to a Mobility Management Entity (MME) or An Evolved Node B (eNB).

Example 16 includes the apparatus of Examples 1-15, wherein the service failure report is sent using an Internet Protocol (IP) connection; and wherein the IP connection is secured with security procedures.

Example 17 is the UE of any of Examples 1-16.

Example 18 is the network entity of any of Examples 1-16

Example 19 includes a diagnostic and assistance server configured to assist in initiating a new service initiation in a mobile communication network, the diagnostic and assistance comprising: processing circuitry to: receive, from a User Equipment (UE), a domain selection assistance information (DSAI) associated with a detection of a service initiation failure, wherein the DSAI includes a service failure report, a service type, and a current domain; and determine a preferred domain for the service type based on the received DSAI, the preferred domain being different than the current domain; and an interface to send domain selection assistance data (DSAD) to the UE for initiation of a new service, the DSAD including the preferred domain for the service type.

Example 20 includes the diagnostic and assistance server of Example 19, where the diagnostic and assistance server is part of an Evolved Node B (eNB).

Example 21 includes the diagnostic and assistance server of Example 19, where the diagnostic and assistance server is part of a Mobility Management Entity (MME).

Example 22 includes the diagnostic and assistance server of Examples 19-21, where the interface is further configured to send a timer value to the UE; and where the UE initiates the new service using the preferred domain if the timer value has not expired.

Example 23 includes the diagnostic and assistance server of Examples 19-22, where the interface is further configured to send a location area; and where the UE initiates the new service using the preferred domain if the UE is within the location area.

Example 24 includes the diagnostic and assistance server of Examples 19-23, where the interface is further configured to send the preferred domain for the service type using an Internet Protocol (IP) connection, wherein the IP connection is secured with security procedures.

Example 25, includes the diagnostic and assistance server of Example 19, where the diagnostic and assistance server is part of a mobile switching center (MSC).

Example 26, includes the diagnostic and assistance server of Example 19, where the diagnostic and assistance server is part of a serving general packet radio service (GPRS) support node (SGSN).

Example 27, includes the diagnostic and assistance server of Example 19, where the diagnostic and assistance server is a stand-alone entity.

Example 28 may include any of the methods of communicating in a wireless network as shown and described herein.

Example 29 may include any of the systems for providing wireless communication as shown and described herein.

Example 30 may include any of the devices for providing wireless communication as shown and described herein.

The foregoing description of one or more implementations provide illustration and description, but is not intended to be exhaustive or to limit the scope of the embodiments disclosed herein to the precise form disclosed. Modifications and variations are possible in light of the above teachings or may be acquired from practice of various implementations of the embodiments disclosed herein.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1-28. (canceled)

29. An apparatus of a User Equipment (UE) for initiating a service in a mobile communication network, the apparatus comprising:
processing circuitry to:
initiate the service for a service type using a current domain;
detect a service initiation failure for the service; and
generate domain selection assistance information (DSAI) based on the detected service initiation failure, wherein the DSAI includes the service type and the current domain; and
transceiver circuitry to send the DSAI to a network entity, wherein the sending of the DSAI is configured to assist the network entity in selecting a preferred domain for the service type when the UE initiates a new service.

30. The apparatus of claim 29, wherein the transceiver circuitry is further configured to:
receive, from the network entity, the preferred domain for the service type, the preferred domain being different than the current domain, and
wherein the processing circuitry is further configured to initiate the new service for the service type using the preferred domain.

31. The apparatus of claim 30, wherein the current domain is a circuit switched (CS) domain, and the preferred domain is a packet switched (PS) domain.

32. The apparatus of claim 31, wherein the preferred domain is accessed using Long Term Evolution (LTE), High Speed Packet Access (HSPA), or Wireless Local Area Network (WLAN).

33. The apparatus of claim 29, wherein the service type is a voice call, a video call, or a short messaging service (SMS).

34. The apparatus of claim 29, wherein the DSAI further includes an access technology.

35. The apparatus of claim 29, wherein the DSAI further includes a location of the UE.

36. The apparatus of claim 29, wherein the DSAI further includes a cause of failure.

37. The apparatus of claim 29, wherein the DSAI further includes a circuit switched (CS) registration status, a packet switched (PS) registration status, or an Internet Protocol (IP) Multimedia Subsystem (IMS) registration status.

38. The apparatus of claim 29, wherein the network entity is a configuration server for management objects (MO).

39. The apparatus of claim 38, wherein the configuration server is an access network discovery and selection function (ANDSF) server within an evolved packet core (EPC).

40. The apparatus of claim 29, wherein the DSAI is sent to the network entity using a non-access stratum (NAS) level.

41. The apparatus of claim 29, wherein the DSAI is sent to the network entity using an Access Stratum (AS) level.

42. A non-transitory computer-readable storage medium that stores instructions for execution by one or more processors to perform operations for initiating a service in a cellular network, the operations to configure a User Equipment (UE) to:
initiate the service for a service type using a current domain;
detect a service initiation failure for the service;
in response to the detected service initiation failure:
re-initiate the service for the service type using an updated domain, the updated domain being different than the current domain; and
generate domain selection assistance information (DSAI), wherein the DSAI includes the service type, the current domain, and the updated domain;
send the DSAI to a network entity, wherein the sending of the DSAI is configured to assist the network entity in selecting a preferred domain for the service type when the UE initiates a new service.

43. The non-transitory computer-readable storage medium of claim 42, further comprising instructions to:
receive, from the network entity, the preferred domain for the service type for the new service, the preferred domain being different than the current domain; and
initiate the new service for the service type using the preferred domain.

44. A diagnostic and assistance server configured to assist in initiating a new service initiation in a mobile communication network, the diagnostic and assistance comprising:
processing circuitry to:
receive, from a User Equipment (UE), a domain selection assistance information (DSAI) associated with a detection of a service initiation failure, wherein the DSAI includes a service failure report, a service type, and a current domain; and
determine a preferred domain for the service type based on the received DSAI, the preferred domain being different than the current domain; and
an interface to send domain selection assistance data (DSAD) to the UE for initiation of the new service, the DSAD including the preferred domain for the service type.

45. The diagnostic and assistance server of claim 44, wherein the diagnostic and assistance server is part of an Evolved Node B (eNB).

46. The diagnostic and assistance server of claim 44, wherein the diagnostic and assistance server is part of a Mobility Management Entity (MME).

47. The diagnostic and assistance server of claim 44, wherein the interface is further configured to send a timer value to the UE; and
wherein the UE initiates the new service using the preferred domain if the timer value has not expired.

48. The diagnostic and assistance server of claim 44, wherein the interface is further configured to send a location area; and
wherein the UE initiates the new service using the preferred domain if the UE is within the location area.

49. The diagnostic and assistance server of claim 44, wherein the diagnostic and assistance server is part of a mobile switching center (MSC).

50. The diagnostic and assistance server of claim 44, wherein the diagnostic and assistance server is part of a serving general packet radio service (GPRS) support node (SGSN).

51. The diagnostic and assistance server of claim 44, wherein the diagnostic and assistance server is a stand-alone entity.
